(19) United States
(12) Patent Application Publication
(10) Pub. No.: US 2026/0031622 A1
(43) Pub. Date: Jan. 29, 2026

(54) CURRENT MANAGEMENT SYSTEM AND METHOD

(71) Applicant: ERC.C ELECTRIC LTD., Brantford (CA)

(72) Inventor: Wael Yousef, Brantford (CA)

(21) Appl. No.: 19/280,184

(22) Filed: Jul. 25, 2025

Related U.S. Application Data
(60) Provisional application No. 63/675,995, filed on Jul. 26, 2024.

(51) Int. Cl. H02J 3/00; H02H 3/08

(52) U.S. Cl. CPC H02J 3/007; H02H 3/08

(57) ABSTRACT

A current management unit, including a principal current path between a first output and a first circuit breaker connection for a first circuit breaker in a breaker panel, to carry a principal load current for a principal load; a controlled current path between a second output and a second circuit breaker connection for a second circuit breaker in the breaker panel, to carry a controlled load current for a controlled load; and a control system operable to selectively connect and disconnect the controlled current path in response to changes in the principal load current, the control system coupled to the principal current path to monitor the principal load current and operable to disconnect the controlled current path when the principal load current exceeds a first threshold and reconnect the controlled current path when the principal load current drops below a second threshold for a predetermined length of time, the second threshold being less than the first threshold.

### CROSS-REFERENCE TO RELATED APPLICATION

This application claims priority to U.S. Provisional Application No. 63/675,995 filed on Jul. 26, 2024, the entire contents of which is hereby incorporated herein by reference.

### FIELD

The description related generally to current management, particularly to a current management unit and method.

### BACKGROUND

U.S. Pat. No. 11,916,381 to Veluru et al. (“Veluru”) purports to disclose systems and methods for managing power distribution from in-home electrical wiring. Veluru purports to disclose a power splitter device including an electrical input source connection with a first input line and a second input line for two hot phases of alternating current electricity, a primary electrical output and a secondary electrical output, the primary electrical output having a first primary output line and a second primary output line and the secondary electrical output having a first secondary output line and a second secondary output line, a first, second, third, and fourth current sensor, a first relay and a second relay, and a control logic microprocessor configured to receive measurements of current, determine an overcurrent condition based upon measurements of current over a period of time and disconnect power from the secondary electrical output connection based upon a determined overcurrent condition.

### SUMMARY

The following summary is intended to introduce the reader to various aspects of the applicant's teaching, but not to define any invention.

According to some aspects, there is provided a current management unit, comprising a principal current path between a first output and a first circuit breaker connection for a first circuit breaker in a breaker panel, to carry a principal load current from the first circuit breaker for a principal load; a controlled current path between a second output and a second circuit breaker connection for a second circuit breaker in the breaker panel, to carry a controlled load current from the second circuit breaker for a controlled load; and a control system operable to selectively connect and disconnect the controlled current path in response to changes in the principal load current, the control system coupled to the principal current path to monitor the principal load current and operable to disconnect the controlled current path when the principal load current exceeds a first threshold and reconnect the controlled current path when the principal load current drops below a second threshold for a predetermined length of time.

In some embodiments, the first threshold is between 17 amps and 23 amps.

In some embodiments, the first threshold is about 20 amps.

In some embodiments, the first threshold is adjustable by a user of the current management unit.

In some embodiments, the second threshold is between 17 amps and 23 amps.

In some embodiments, the second threshold is about 20 amps

In some embodiments, the second threshold is adjustable by a user of the current management unit.

In some embodiments, the predetermined length of time is about 30 seconds.

In some embodiments, the predetermined length of time is adjustable by a user of the current management unit.

In some embodiments, the first and second thresholds are equal.

In some embodiments, the control system is a powered control system including a current switch coupled to a relay controlling a contactor in the controlled current path.

In some embodiments, the current management unit includes a power inlet to receive power form the breaker panel.

According to some aspects, there is provided a current management system, comprising a current management unit; and a breaker panel, a first circuit breaker connection of the current management unit coupled to a first circuit breaker on the breaker panel to receive power therethrough, and a second circuit breaker connection of the current management unit coupled to the second circuit breaker on the breaker panel to receive power therethrough.

In some embodiments, the first and second circuit breakers are 60 amp breakers.

In some embodiments, the current management unit is a powered unit and includes a power outlet coupled to a third circuit breaker on the breaker panel, the third circuit breaker being a 15 amp breaker.

According to some aspects, there is provided a method of managing current use, comprising coupling a current management unit to an electrical panel, a principal current path of the current management unit coupled to a first circuit breaker on the electrical panel and a controlled current path of the current management unit coupled to a second circuit breaker on the electrical panel; coupling the principal current path of the current management unit to the principal load; and coupling the controlled current path to the controlled load.

In some embodiments, the principal load is a large appliance and the controlled load is an electric vehicle charger.

In some embodiments, the principal load is a stove.

In some embodiments, the first threshold is between 17 amps and 23 amps.

In some embodiments, the first threshold is about 20 amps.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a circuit diagram for a current management unit;

FIG. 2 is a schematic diagram of the current management unit of FIG. 1 installed with a breaker panel; and

FIG. 3 is a flow diagram of a method of using a current management unit.

### DETAILED DESCRIPTION

Various apparatuses or processes will be described below to provide an example of an embodiment of each claimed invention. No example described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. It should be noted that the term “coupled” used herein indicates that two elements can be directly coupled to one another or coupled to one another through one or more intermediate elements.

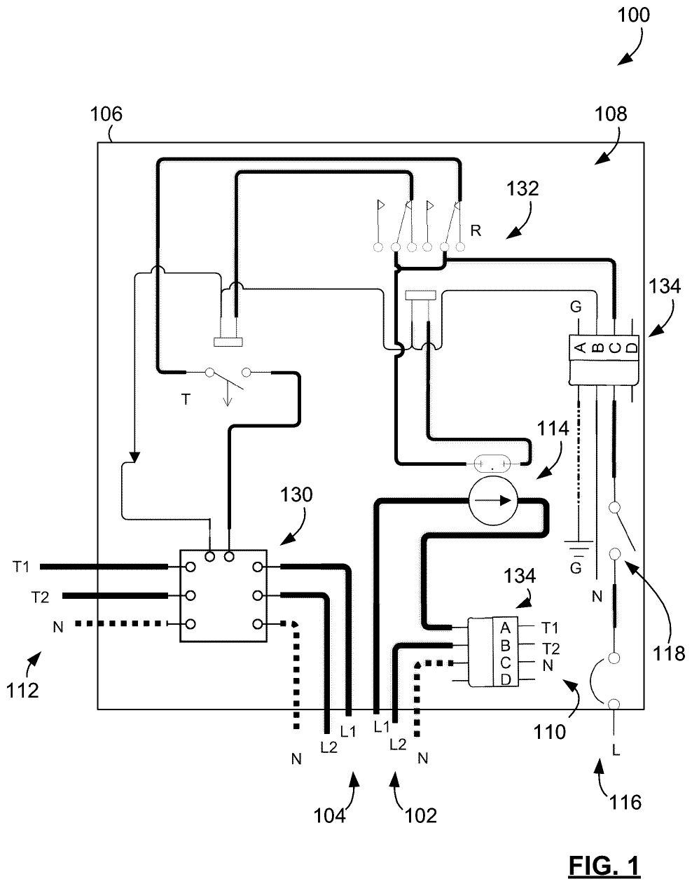

Referring to FIG. 1, an example current management unit 100 is illustrated. Current management unit 100 includes a first input 102 and a second input 104. The first input 102 is coupled to a first output 110 to provide current thereto. A principal current path extends between the first input 102 and the first output 110. The second input 104 is selectively coupled to a second output 112 to selectively provide current thereto. A controlled current path extends between the second input 104 and the second output 112. The current management unit 100 prioritizes the connection between the first input 102 and the first output 110, and selectively couples the second input 104 and the second output 112 when current between the first input 102 and the first output 110 is low. This allows the controlled load to draw current as long as the current needed for the primary load is low. The current management unit 100 disconnects the second input 104 and the second output 112 from one another when the current between the first input 102 and the first output 110 is high to prevent overloading the electrical panel.

Current management unit 100 may be connected to an electrical panel via two circuit breakers. In some embodiments, the first input 102 is connected to a first circuit breaker on the panel and the second input 104 is connected to a second circuit breaker on the panel. In some embodiments, the current management unit 100 may be provided as a single device or unit to be hooked up to the circuit breakers on the electrical panel. The current management unit 100 may include, e.g., a housing 106 containing a control circuit 108, such as a JBH-4960-KO™ housing box. In some embodiments, the housing 106 contains the circuit 108. The inventor has found that, in some embodiments, limiting a largest dimension of the housing 106 to 10 inches or less allows for easy placement of the unit 100.

The first input 102 is operable to provide current to a principal load at the first output 110. In some embodiments current between the first input 102 and the first output 110 is limited within the current management unit 100 to a maximum primary current. The second input 104 is operable to provide current to a controlled load at the second output 112. In some embodiments current between the second input 104 and the second output 112 is limited within the current management unit 100 to a maximum controlled current. The current management unit 100 may be used with large principal and controlled loads, such as an electric vehicle charger, a hot tub, and/or a large appliance like a stove. The primary load may be, e.g., a stove. The secondary load may be, e.g., an electric vehicle charger.

One or more components of the unit 100 are powered. Power may be provided from any suitable power supply, such as an on-board energy storage device (e.g., battery or capacitor) or an external supply. In some embodiments, power is supplied to one or more components of the current management unit 100 via power inlet 116. The power inlet 116 is also connected to the common breaker panel. The power inlet 116 is connected to a third circuit breaker on the panel. The unit 100 includes an on-off switch 118, such as the GSW-51™. In some embodiments, when the unit 100 is off, the secondary line is disconnected (i.e., defaulting to no power to secondary outlet 112). In some embodiments, when the unit 100 is off, the secondary line is connected (i.e., defaulting to providing power to secondary outlet 112). Since the first and second lines are coupled to different circuit breakers in the panel, they can safely be used simultaneously, with the breaker panel itself and/or the individual circuit breakers limiting overall usage.

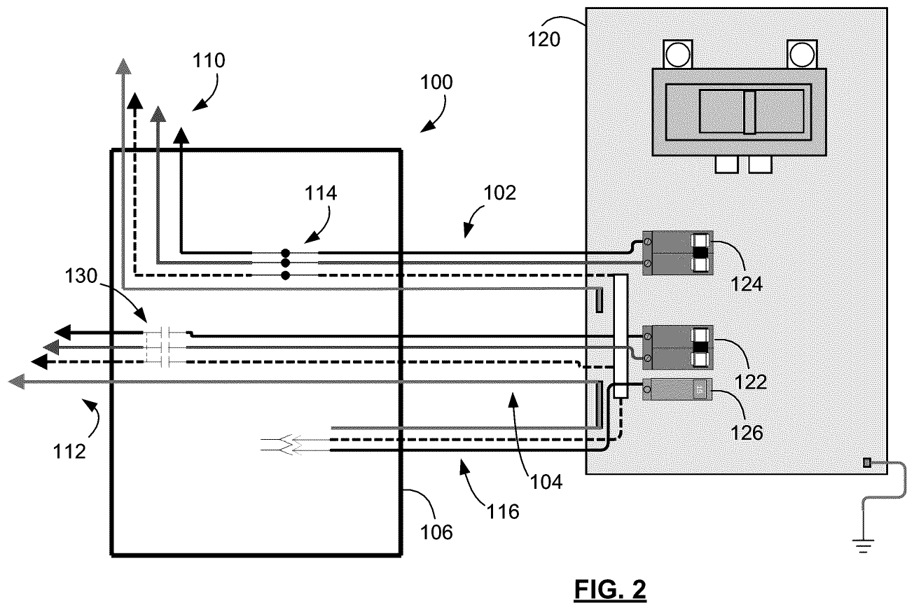

Referring to FIG. 2, the current management unit 100 is illustrated installed with a breaker panel 120. The breaker panel may be, e.g., a 100 amp panel. In some embodiments, the current management unit 100 is installed outside the breaker panel box. In some embodiments, the current management unit 100 is installed adjacent the breaker panel box. The first input 102 is connected to a first circuit breaker 122. The second input 104 is connected to a second circuit breaker 124. The power inlet 116 is connected to a third circuit breaker 126. The first and second circuit breakers 122, 124 may be the same size. In some embodiments, the first and second circuit breaker 122, 124 are 60 amp breakers. The third circuit breaker 126 may be a smaller circuit breaker. In some embodiments, the third circuit breaker 126 is a 15 amp breaker. As exemplified in FIG. 2, in some embodiments primary inlet 102, controlled inlet 104, and/or power inlet 116 are directly wired to breakers on the panel 120.

Referring again to FIG. 1, in use, the current provided to the first output 110 is monitored. In some embodiments, a current switch 114 is provided between the first input 102 and the first output 110 to monitor current provided to the first output 110. When current between the first input 102 and the first output 110 exceeds a predetermined first threshold, the current management unit 100 disconnects the second input 104 and the second output 112 to prevent current from being provided to the controlled load. When current between the first input 102 and the first output 110 falls below a predetermined second threshold for a predetermined amount of time, the current management unit 100 reconnects the second input 104 and the second output 112 to allow current to be provided to the controlled load. The first and second thresholds may be the same, although it will be appreciated that in some embodiments they may be different.

In some embodiments, the inventor has discovered that the first threshold triggering disconnection of the controlled load should be a value between 17 and 23 amps. The inventor has found that in practice many primary loads use a current similar or slightly less than these values. For examples, many stoves can use up to 40 amps, but often use only 18 amps when running (e.g., when only some burners are on). Setting the value close to this value, optionally slightly higher, allows for limited use of the primary load without disconnection of the secondary load, while dramatically reducing the risk of overloading the breaker panel 120. In some embodiments, the inventor has found that setting the first threshold higher than 23 amp results in an undesirable risk of overloading the breaker panel. In some embodiments, the inventor has found that setting the first threshold higher than 23 amps is acceptable, such as applications where the panel 120 as a whole is likely to draw less than 100 amps. In some embodiment, the inventor has found that setting a first threshold of 25 amps is appropriate. It will be appreciated that in some embodiments the threshold may be higher than 25 amps or lower than 17 amps. In some embodiments, the inventor has discovered that the first threshold should be about 20 amps.

The second threshold may be the same as the first threshold. However, it will be appreciated that in some embodiments the second threshold is less than the first threshold to require the current usage to drop before the secondary outlet is available. In some embodiments, the second threshold is a current less than 20 amps over a predetermined time period. The predetermined time period may be any reasonable time period indicating that the high-current usage of the primary load is complete, to prevent rapid changes in the configuration of the unit 100. The inventor has found that, in some embodiments, a time period of 30 seconds is appropriate.

It will be appreciated that in other embodiments, other thresholds may be chosen. One or both of the thresholds may be fixed. One or both of the thresholds may be adjustable. One threshold may be adjustable while the other is fixed. Both thresholds may be adjustable, either dependently so that adjusting one adjusts the other (e.g., to the same value or a fixed spread or ratio) or they may be adjustable independently. For example, a threshold may be adjustable by adjusting a set screw on a device containing the circuit 108, such as a set screw adjusting a set point of the current transformer 114. Adjustment of a threshold may be limited to a predetermined range. In some embodiments, the range is less than 25 amps or between 17 and 23 amps.

In some embodiments, the current management unit 100 includes a circuit which automatically connects and/or disconnects the current path to the controlled load based on current provision to the primary load.

The example circuit 108 connects and disconnects the second input 104 and second output 112 automatically in response to current usage by the primary load. The circuit 108 may respond to current use in the primary line in any suitable way. In some embodiments, the circuit 108 includes the current switch 114 monitoring current through the primary line. The current switch 114 may be a current transformer. The current switch may be, e.g., a MCS-111050™. When the primary current exceeds the first threshold, the circuit 108 selectively decouples the input 104 and the output 112 of the secondary load.

The circuit 108 may selectively couple the input 104 and the output 112 of the secondary load in any suitable way. In some embodiments, the circuit 108 includes a contactor 130 between the secondary input 104 and the secondary output 112. The contactor 130 selectively joins the input 104 to the output 112. Any suitable contactor 130 may be used, such as a GMC-40™. The contactor may be controlled in any suitable way. In some embodiments, the unit 100 includes a relay 132 through which the contactor 130 is controlled. Any suitable relay may be used, such as an MY2N-GS™. The relay 132 may be a time delay relay to recouple the secondary line input and outlet 104, 112 only after the second threshold has been met for the predetermined length of time (e.g., 30 seconds).

The circuit 108 may include one or more splice block 134, such as an LFS13003Z™. Referring to FIG. 1, the primary outlet 110 may include a splice block 134. The power input 116 may include a splice block 134.

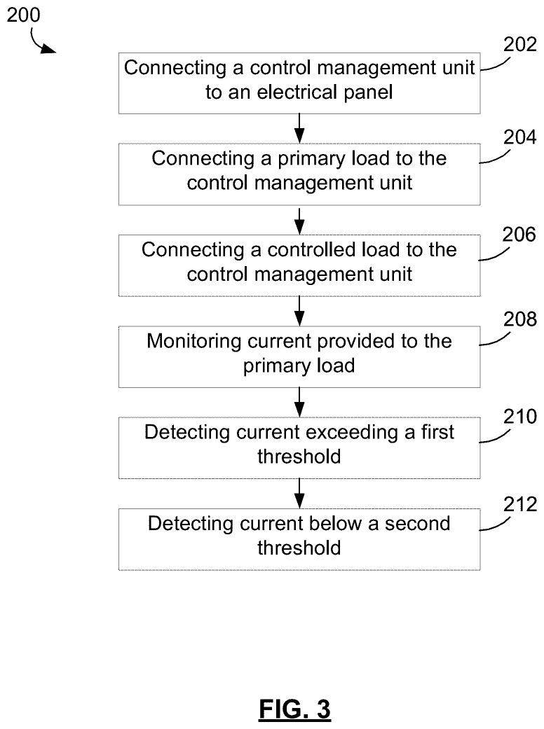

Referring now to FIG. 3, illustrated is an example method 200 of using a current management unit 100. The method 200 includes, at step 202, connecting the control management unit 100 to an electrical panel. Step 202 includes coupling a primary input to a first circuit breaker on a panel and coupling a secondary input to a second, separate circuit breaker on the common panel. Step 202 may also include coupling a power input for the current management unit to a third, separate, circuit breaker on the common panel.

At steps 204 and 206, method 200 includes connecting primary and controlled loads to the current management unit 100. At step 208, the method 200 includes monitoring current to the primary load. At step 210, the method 200 includes detecting current to the primary load exceeding a predetermined first threshold and responding by limiting current to the controlled load. At step 212, the method 200 includes detecting current to the primary load falling below a second threshold and responding by removing the limitations to the controlled load.

It will be appreciated that numerous specific details are set forth in order to provide a thorough understanding of the example embodiments described herein. However, it will be understood by those of ordinary skill in the art that the embodiments described herein may be practiced without these specific details. Furthermore, this description and the drawings are not to be considered as limiting the scope of the embodiments described herein in any way, but rather as describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies. It should be noted that the term “coupled” used herein indicates that two elements can be directly coupled to one another or coupled to one another through one or more intermediate elements.

Various embodiments have been described herein by way of example only. Various modification and variations may be made to these example embodiments without departing from the spirit and scope of the invention, which is limited only by the appended claims.

1. A current management unit, comprising:
a principal current path between a first output and a first circuit breaker connection for a first circuit breaker in a breaker panel, to carry a principal load current from the first circuit breaker for a principal load;
a controlled current path between a second output and a second circuit breaker connection for a second circuit breaker in the breaker panel, to carry a controlled load current from the second circuit breaker for a controlled load; and
a control system operable to selectively connect and disconnect the controlled current path in response to changes in the principal load current, the control system coupled to the principal current path to monitor the principal load current and operable to disconnect the controlled current path when the principal load current exceeds a first threshold and reconnect the controlled current path when the principal load current drops below a second threshold for a predetermined length of time.

2. The current management unit of claim 1, wherein the first threshold is between 17 amps and 23 amps.

3. The current management unit of claim 2, wherein the first threshold is about 20 amps.

4. The current management unit of claim 1, wherein the first threshold is adjustable by a user of the current management unit.

5. The current management unit of claim 1, wherein the second threshold is between 17 amps and 23 amps.

6. The current management unit of claim 5, wherein the second threshold is about 20 amps

7. The current management unit of claim 1, wherein the second threshold is adjustable by a user of the current management unit.

8. The current management unit of claim 1, wherein the predetermined length of time is about 30 seconds.

9. The current management unit of claim 1, wherein the predetermined length of time is adjustable by a user of the current management unit.

10. The current management unit of claim 1, wherein the first and second thresholds are equal.

11. The current management unit of claim 1, wherein the control system is a powered control system including a current switch coupled to a relay controlling a contactor in the controlled current path.

12. The current management unit of claim 1, wherein the current management unit includes a power inlet to receive power form the breaker panel.

13. A current management system, comprising:
the current management unit of claim 1; and
the breaker panel, the first circuit breaker connection coupled to a first circuit breaker on the breaker panel to receive power therethrough, the second circuit breaker connection coupled to the second circuit breaker on the breaker panel to receive power therethrough.

14. The current management system of claim 13, wherein the first and second circuit breakers are 60 amp breakers.

15. The current management system of claim 14, wherein the current management unit is a powered unit and includes a power outlet coupled to a third circuit breaker on the breaker panel, the third circuit breaker being a 15 amp breaker.

16. A method of managing current use, comprising:
coupling the current management unit of claim 1 to an electrical panel, the principal current path coupled to a first circuit breaker on the electrical panel and the controlled current path coupled to a second circuit breaker on the electrical panel;
coupling the principal current path of the current management unit to the principal load; and
coupling the controlled current path to the controlled load.

17. The method of claim 16, wherein the principal load is a large appliance and the controlled load is an electric vehicle charger.

18. The method of claim 17, wherein the principal load is a stove.

19. The method of claim 18, wherein the first threshold is between 17 amps and 23 amps.

20. The method of claim 19, wherein the first threshold is about 20 amps.
